(19) United States
(12) Patent Application Publication
(10) Pub. No.: US 2011/0047876 A1
(43) Pub. Date: Mar. 3, 2011

(54) AUTOMATIC DOOR

(75) Inventors: Blue Houser, Edgemoor, SC (US); Jeffrey T. Schoener, Charlotte, NC (US)

(73) Assignee: YALE SECURITY INC., Monroe, NC (US)

(21) Appl. No.: 12/873,647

(22) Filed: Sep. 1, 2010

Related U.S. Application Data
(60) Provisional application No. 61/239,558, filed on Sep. 3, 2009.

(51) Int. Cl. E05F 15/18; B67D 7/06; B23P 17/00; E06B 7/00

(52) U.S. Cl. 49/70; 222/192; 29/592; 49/506

(57) ABSTRACT

A hand cleaner station and automatic door operator for opening a door. The hand cleaner station includes a dispenser for dispensing a cleaning material and a first input device. The first input device causes the dispenser to dispense the cleaning material and to initiate a signal from the dispenser. The signal causes a door operator controller to direct a door operator motor to open the door. A second input device may be provided that also causes the dispenser to initiate a signal. The second input device does not cause the dispenser to dispense the cleaning material, but again the signal causes the door operator controller to direct the door operator motor to open the door. A method of operating an automatic door operator includes selecting between use of the first and second input devices for operating the door.

### CROSS-REFERENCE TO RELATED APPLICATION

This application claims the benefit of U.S. Provisional Application No. 61/239,558, filed Sep. 3, 2009, the contents of which are hereby incorporated by reference in their entirety.

### BACKGROUND

The automatic door disclosed herein relates generally to the field of door operators, and particularly to door operators that are motorized and controlled for automatically opening a door.

The purpose of door operators is to open and close doors. Automatic door operators are conventionally used on public buildings and residences to allow for access by the physically disabled or where manual operation of the door may be inconvenient to users. In public facilities, it is a required American National Standard that doors which provide ingress and egress have the ability to open automatically in order to allow handicapped people passage through the doorway.

A variety of electro-mechanical automatic door operators are known. A typical door operator includes an electric motor and a linkage assembly for operatively coupling the drive shaft of the motor to a door so that the door will be opened and closed when the drive shaft rotates. Activation of the door operator is initiated by means of an electric signal generated in a variety of ways such as, for example, a pressure switch, an ultrasonic or photoelectric presence sensor, motion sensors, radio transmitters, wall switches, and the like. The door may then be closed under power or with a door closer. A conventional door closer uses an internal spring mechanism that is compressed during the opening of the door for storing sufficient energy so that the door can be returned to a closed position without the input of additional electrical energy.

Some door operator systems are provided with clutch mechanisms between the motor and the linkage assembly that enable the door to be moved freely under manual power. Various clutch mechanisms decouple powered opening systems during the closing cycle, which is particularly necessary in the event of an interruption of power supply.

### SUMMARY

In accordance with one embodiment described herein, a hand cleaner station for opening a door is provided, with a door operator motor and a door operator controller being associated with the door. The hand cleaner station includes a dispenser for dispensing a cleaning material and a first input device. The first input device is for causing the dispenser to dispense the cleaning material and to initiate a signal from the dispenser when the first input device is actuated. The signal is adapted to cause the door operator controller to direct the door operator motor to open the door. The hand cleaner station may further include a second input device for causing the dispenser to initiate a signal when the second input device is actuated. The second input device does not cause the dispenser to dispense the cleaning material, but again the signal is adapted to cause the door operator controller to direct the door operator motor to open the door.

In accordance with another embodiment described herein, an automatic door operator for a door is provided. The automatic door operator includes a motor adapted to be operatively coupled to the door to open the door, a door operator controller electrically connected to the motor to control the operation of the motor, and a hand cleaner station. The hand cleaner station is in operative communication with the door operator controller, and includes a dispenser for dispensing a cleaning material and a first input device. The first input device is for causing the dispenser to dispense the cleaning material and to initiate a signal from the dispenser when the first input device is actuated. The signal is for causing the door operator controller to direct the motor to open the door. The hand cleaner station may further include a second input device for causing the dispenser to initiate a signal when the second input device is actuated. The second input device does not cause the dispenser to dispense the cleaning material, but again the signal is for causing the door operator controller to direct the motor to open the door.

In accordance with another embodiment described herein, a method of making a hand cleaner station for opening a door is provided, with a door operator motor and a door operator controller being associated with the door. The method includes providing a dispenser for dispensing a cleaning material, providing a first input device, and providing a second input device. The first input device is for causing the dispenser to dispense the cleaning material and to initiate a signal from the dispenser when the first input device is actuated, the signal adapted to cause the door operator controller to direct the door operator motor to open the door. The second input device is for causing the dispenser to initiate a signal when the second input device is actuated. The second input device does not cause the dispenser to dispense the cleaning material, but again the signal is adapted to cause the door operator controller to direct the door operator motor to open the door.

In accordance with another embodiment described herein, a method of operating an automatic door operator for a door in a doorway is provided, with a door operator motor and a door operator controller being associated with the door. The method includes selecting between use of input devices for operating the door. The input devices include a first input device for causing the dispenser to dispense a cleaning material and to initiate a signal from the dispenser when the first input device is actuated. The signal is adapted to cause a door operator controller to direct a door operator motor to open the door. The second input device is for causing the dispenser to initiate a signal when the second input device is actuated. The second input device does not cause the dispenser to dispense the cleaning material, but again the signal is adapted to cause the door operator controller to direct the door operator motor to open the door. Either the first or second input device is actuated. If the first input device is selected, hands are cleaned with the cleaning material. The doorway is passed through after the door opens.

### BRIEF DESCRIPTION OF THE DRAWINGS

For a more complete understanding of the automatic door opener described herein, reference should now be had to the embodiments shown in the accompanying drawings and described below. In the drawings:

FIG. 1 is front elevation view of an embodiment of a hand cleaner station and a door operator in position on a door with a pull side linkage assembly.

FIG. 2 is an enlarged detail view of the door operator shown in FIG. 1.

FIGS. 3 and 4 are each a perspective view of embodiments of the hand cleaner station of FIG. 1.

FIGS. 5-7 are exemplary embodiments of electrical circuits for use with the door operator and hand cleaner station of FIG. 1.

### DETAILED DESCRIPTION

Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise.

As used herein, the term “open position” for a door means a door position other than a closed position, including any position between the closed position and a fully open position as limited only by structure around the door frame, which can be up to 180 degrees from the closed position.

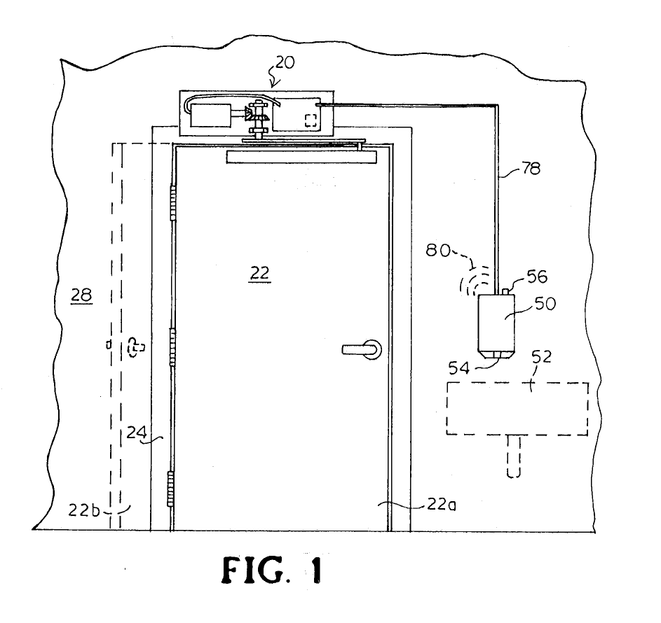

Referring now to the drawings, wherein like reference numerals designate corresponding or similar elements throughout the several views, an embodiment of a door operator is shown in FIG. 1, and is generally designated at 20. The door operator 20 is mounted adjacent to a door 22 in a door frame 24 for movement of the door 22 relative to the frame 24 between a closed position 22a and an open position 22b, represented in dashed lines. The door 22 is of a conventional type and is pivotally mounted to the frame 24 for movement from the closed position 22a to an open position 22b for opening and closing an opening through a building wall 28 to allow a user to travel from one side of the wall 28 to the other side of the wall 28.

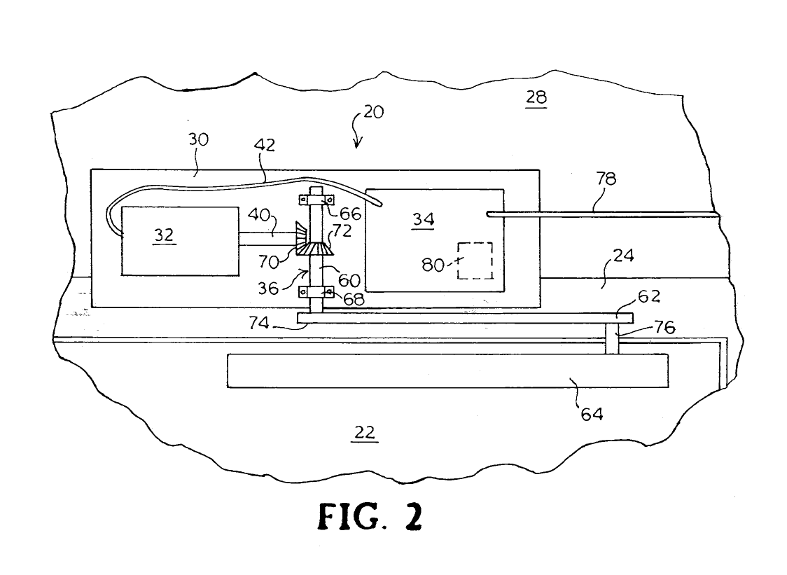

Referring to FIGS. 1 and 2, the door operator 20 includes a back plate 30, a motor assembly 32, a door operator controller 34, and an operator arm assembly 36 for operably coupling the door operator 20 to a door 22. A clutch assembly, not shown, may also be provided, as may a conventional door closer. The orientation of the door 22 and door operator 20 is a pull side configuration, in which the operator arm assembly 36 pulls the door 22 open towards the same side on which the door operator 20 and hinges 26 are disposed. Alternatively, the orientation could be a push side configuration, in which the operator arm assembly 36 may include a linkage of, for example, two arm links to permit the door operator 20 to push the door 22 open in the direction away from the side of the door 22 on which the door operator 20 is located, as is known in the art.

The back plate 30 is securely mounted to the upper edge of the door frame 24 using mounting screws or other fasteners. The back plate 30 extends generally horizontally with respect to the door frame 24. The motor assembly 32, operator arm assembly 36, and door operator controller 34 are mounted to the back plate 30.

A cover (not shown) may be attached to the back plate 30 to surround and enclose the components of the door operator 20 that are within the limits of the back plate 30 to reduce dirt and dust contamination, and to provide a more aesthetically pleasing appearance. It is understood that although the back plate 30 is shown mounted directly to the door frame 24, the back plate 30 could be mounted to the wall 28 adjacent the door frame 24, concealed within the wall 28 or door frame 24, or mounted to the door 22 with the operator arm assembly 36 mounted to the door frame. Concealed door operators 20 are well known in the art of automatic door operators. Suitable door operators include, but are not limited to 6900 Powermatic®, 5900 Series X-in™, and 5700 Series LEO® models from Norton Door Controls of Monroe, North Carolina, an ASSA ABLOY Group company. Suitable door operators are also described in U.S. Pat. No. 7,361,096, entitled “Door Operator,” issued Jan. 8, 2008, and U.S. patent application Ser. No. 12/603,871, entitled “Door Operator,” filed Oct. 22, 2009, the entire contents of both of which are incorporated herein by reference.

In the embodiment shown, the motor assembly 32 includes an electric motor and a gear train, which may include a planetary gear, mounted to the back plate 30 with a mounting bracket and bolts, not shown. The motor may be a conventional 3 phase AC electric reversible motor with a motor drive shaft 40. A portion of the drive shaft 40 extends from the housing of the motor assembly 32. The motor may be reversible such that the rotation of the motor in one direction will cause the drive shaft 40 to rotate in one direction and rotation of the motor in the opposite direction will cause the drive shaft 40 to rotate in the opposite direction. Such motors are widely commercially available and the construction and operation of such motors are well known; therefore, the details of the motor are not described in specific detail herein. A suitable motor for use in the door operator 20 is available from Brother of Somerset, N.J., as model no. BHLM15L-240TC2N, which is a 240 volt motor providing 1/50 HP and a gear ratio of 240:1.

It is understood by those skilled in the art that the electric motor may be selected and sized according to the dimensions and weight of the hinged door 22, and may include a gear train disposed within a casing and include a gear train input shaft (not shown) coupled to the drive shaft 40 of the motor. The gear train may provide a proper reduction in output drive of the motor necessary to move the hinged door 22 at an appropriate speed.

The door operator controller 34 regulates the operation of the motor and thus regulates the opening and closing of the door 22. The door operator controller 34 is in communication with the motor, which receives signals from the door operator controller 34. Such communication may be via electrical wire 42. The door operator controller 34 includes a suitable microprocessor for controlling the operation of the motor and functions to generate appropriate signals to the motor for rotating the drive shaft 40 in one direction to open the door 22 or the other direction for closing the door 22. The door operator controller 34 may also function to maintain the door 22 in an open position for a selected period of time for enabling a person to pass through the door opening. The amount of time that the door 22 is held open may be varied and can be programmed into the door operator controller 34 at the time of installation, or altered at any time thereafter by reprogramming the controller. The door operator controller 34 may also be adjusted to generate signals that control the speed of the motor for controlling the speed of opening the door 22. It is understood that although the door operator controller 34 is shown mounted to the back plate 30, the door operator controller 34 could also be housed internally within the wall 28, a ceiling, or remotely, such as in a mechanical room, for example. A suitable door operator controller 34 for use with the door operator 20 described herein is well known in the art; one is available from Minarik Electric Co. of South Biloxi, Ill. A description of a suitable door operator controller is provided in U.S. patent application Ser. No. 12/845,973, entitled “Door Operator with Electrical Back Check Feature,” filed Jul. 29, 2010, the entire contents of which are incorporated herein by reference.

The door operator controller 34 is part of an overall control system (not shown) which may include a device in electrical communication with the door operator controller 34 for allowing a user to selectively control the delivery of electrical energy to the motor. The device is operable to generate a door movement signal to the door operator controller 34 which, in turn, is responsive to receiving the door movement signal to control operation of the motor so as to selectively cause the motor to rotate the drive shaft 40 and thereby effect powered opening of the door 22.

The device for providing a signal to the door operator controller 34 is, in one embodiment, is a hand cleaner station including a hand soap or hand sanitizer dispenser 50. The dispenser 50 may be mounted on the wall 28, a post, or the like adjacent to the door 22. When used herein, the terms “cleaning fluid,” “fluid,” “cleaner,” “cleaning solution,” and “cleaning composition” should be understood to refer to soap, sanitizer, lotion, a combination thereof, or any material used on a person's hands, and such materials may take forms including but not limited to solid, liquid, gel, or foam. If hand soap is the cleaning fluid, a sink 52 may be provided in proximity to the dispenser 50. The arrangement may be such that a user actuates a primary input device 54, such as by pressing a lever or being detected by a sensor to activate the dispenser 50 to dispense cleaning fluid, commonly through actuation of a valve in the dispenser 50, and which further causes the dispenser 50 to initiate a signal to the door operator controller 34 to initiate a door opening sequence. The embodiment of a dispenser 50 may also include an override input device 56 that does not cause cleaning fluid to be dispensed, as may be desired by someone who wishes to pass through the door way without receiving cleaning fluid in their hands. In some cases the first step of the door opening sequence may include unlocking the door, while in others the door begins as unlocked.

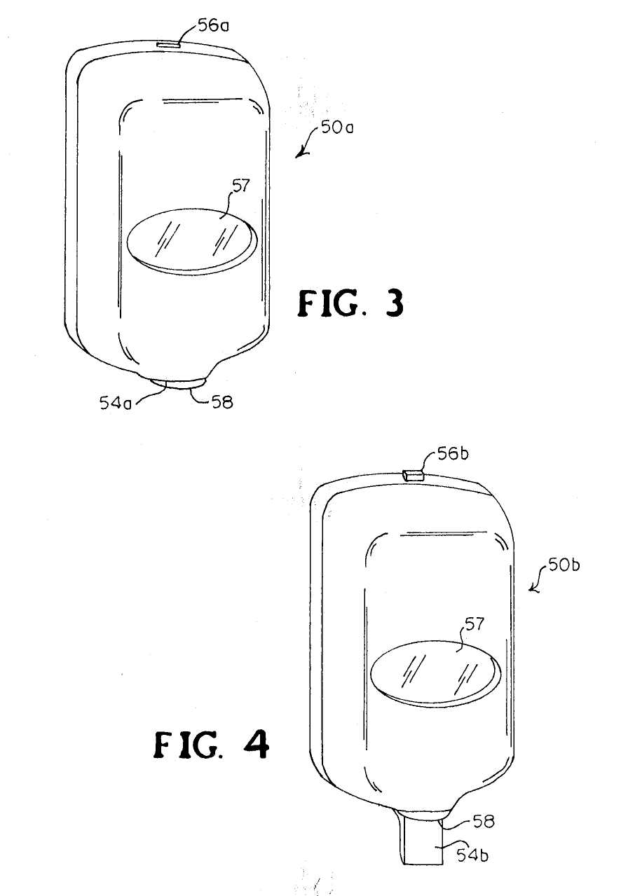

Various input devices are suitable for use as part of the dispenser 50 for either the primary input device 54 or override input device 56, including any type of switch, sensors and actuators, such as optical sensors, mechanical switching devices, infrared motion sensors, radio frequency sensors, photoelectric cells, ultrasonic presence sensor switches, and the like. For example, primary input device 54 may be, as shown in FIG. 1, either a motion detector, proximity sensor, or a mechanical lever that is actuated to dispense cleaning solution and activate the door operator 20. An on/off switch, not shown in FIGS. 1 and 2, may be provided to allow the door operator to be set for manual-only operation. The on/off switch and the override input device 56 may be omitted, which may be required to force a user of the door to actuate the dispenser and use cleaning solution. FIG. 3 shows an embodiment of a dispenser 50a with motion sensors at top and bottom, being the override input device 56a and primary input device 54a, respectively, with a viewing window 57 to display whether there is fluid in the dispenser 50a, and an outlet 58 through which the cleaning fluid passes at the bottom. FIG. 4 shows an embodiment of a dispenser 50b with a mechanical lever at the bottom and a button at the top, being the primary input device 54b and override input device 56b, respectively, also with a viewing window 57 to display whether there is fluid in the dispenser 50b, and an outlet 58 through which the cleaning fluid passes at the bottom.

As a result of implementing an input device, an automatically operable door may be caused to open by mere proximity of a person's hands to the dispenser 50. Such proximity may cause the door to operate by virtue of the interruption of a light beam, distortion of an electrical field, or by actual physical closing of the switch by contact with the person's hands. Consequently, the particular manner for generating a door movement signal to the door operator controller 34 for energizing the motor can be accomplished through any of numerous well known means.

As shown in FIG. 2, the operator arm assembly 36 is provided for applying opening and closing force to the door. An embodiment of the operator arm assembly 36 includes an output shaft 60, an operator arm 62, a track 64, and a roller (not visible) in the track 64, and may include a clutch assembly (not shown). The output shaft 60 is constrained to a vertical orientation by passing through bearings that are disposed in openings in a top brace 66 and a bottom brace 68 that are mounted to the back plate 30 with bolts. The output shaft 60 is coupled to the drive shaft 40 with a bevel gear 70 that engages an output shaft bevel gear 72 to translate the direction of rotation 90 degrees. However, it is anticipated that other forms of gearing and linkages may be used, such as worm gears, helical gears, rack and pinion arrangements and the like to translate the rotation 90 degrees. Alternative arrangements are feasible; for example, the orientation of the drive shaft 40 and the output shaft 60 axes may be parallel or coaxial.

The operator arm 62 may be an elongated member that has one end that may be considered an arm hub 74 through which the output shaft 60 extends. At the opposite end of the operator arm 62 a rod 76 is secured to the arm 62, and the roller is secured to the rod 76 within the track 64. The track 64 is mounted to the door 22, and the roller rolls in the track 64 and may apply opening or closing force to the track 64 as the door 22 pivots.

The door operator 20 includes an electrical circuit for providing electrical communication between a source of electrical energy and the various electrical components. Apertures are formed in the back plate 30 for passage of electrically conductive wiring (not shown), including wiring from the door operator controller 34 to the source of electrical energy, from the dispenser 50 to the door operator controller 34 with wire 78 in one embodiment, and the wire 42 between the door operator controller 34 and the motor 32. As an alternative to a wired connection between the dispenser 50 and the door operator controller 34, wireless communication is shown generally with a signal from the dispenser 50 and a receiver 80 at the door operator controller 34.

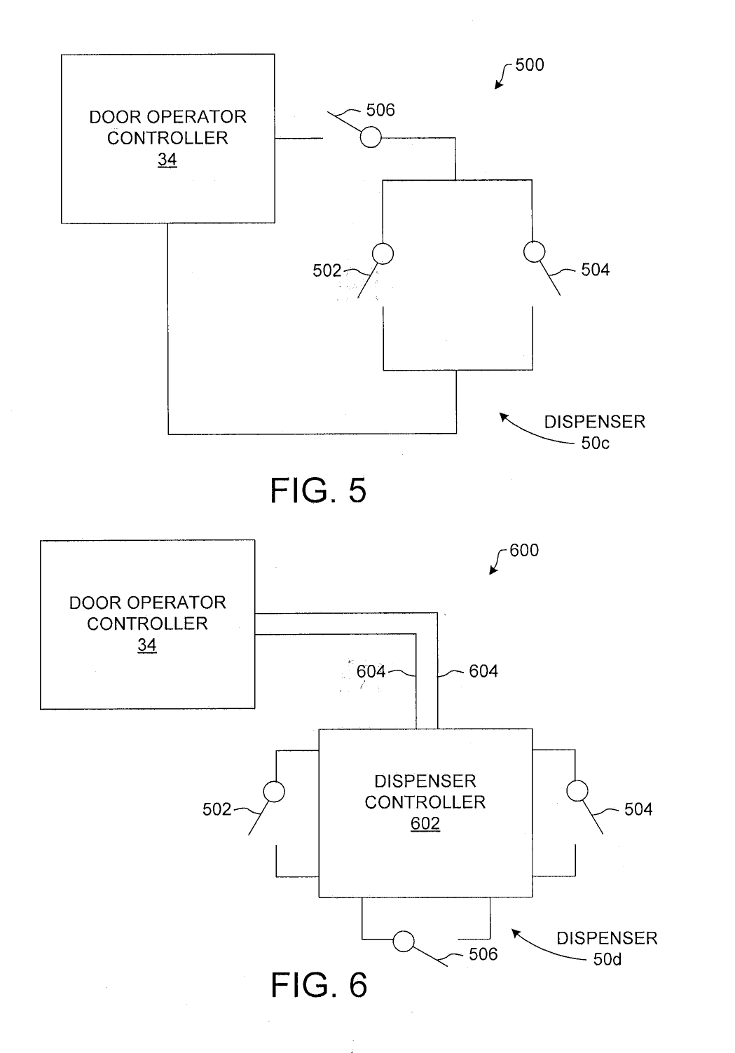

FIGS. 5-7 show various embodiments of circuits 500, 600, 700 that may be implemented with the dispenser 50 and door operator 20; such circuits are non-inclusive and other circuits may be provided as known by one of ordinary skill in the art. The circuit of FIG. 5 includes a dispenser 50c with a first switch 502 that is actuated by a primary input device 54 to dispense cleaning fluid and complete the circuit to send a signal to the door operator controller 34. A second switch 504 may be provided that is actuated by the override input device 56. A third switch may be provided that is an on/off switch 506 that allows the hand cleaner station 20 to dispense cleaning fluid, but not send a signal to the door operator controller 34, as may be desired to provide manual-only operation of the door.

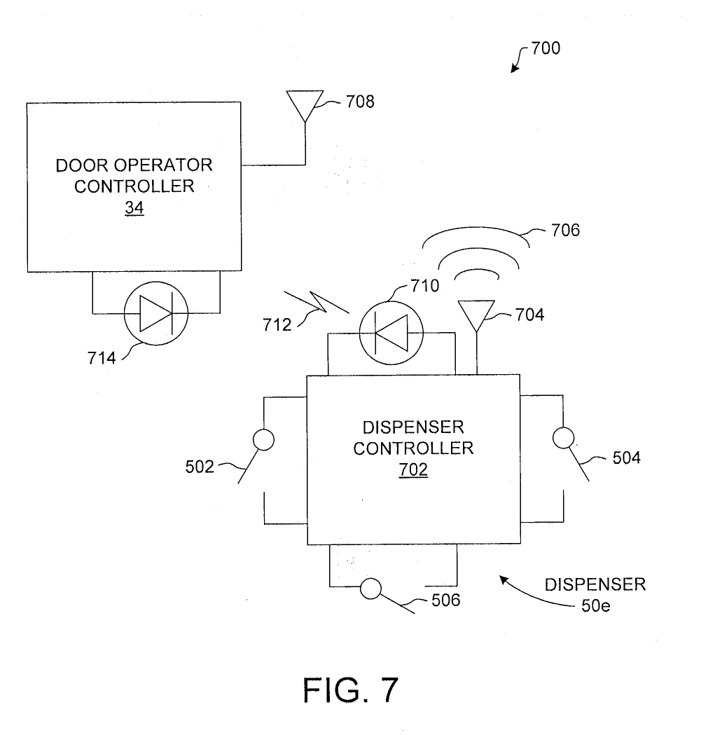

FIGS. 6 and 7 show embodiments of dispensers 50d, 50e, each including associated circuitry and hardware (not shown). Switches 502, 504, 506 are provided as in the circuit 500 of FIG. 5 for actuation by a primary input device 54, actuation by an override input device 56, and actuation of an on/off switch 506. In FIG. 6, the door operator controller 34 and the dispenser controller 602 are hard wired with wiring 604. As shown in FIG. 7, as an alternative to wired communication between the dispenser 50e and the door operator controller 34, a dispenser controller 702 may have associated hardware that generates a wireless signal. Wireless communication may be Bluetooth, WiFi, other radio frequency (RF) format, or infrared (IR) transmission. For RF communication, an RF-emitting transmitter 604 may be provided, electrically connected with the hand cleaner station controller 702, to emit an RF signal 706. An RF receiver 708 may be electrically connected to the door operator controller 34. For IR signal transmission, an IR signal generator 710 may be provided, electrically connected with the dispenser controller 50e, to emit an IR signal 712. An IR receiver 714 may be electrically connected to the door operator controller 34. Hardware associated with the dispenser controller 602, 702 may include RF and/or IR transmitters and/or receivers.

In the three circuits 500, 600, 700 shown, second switches 504 that are actuated by override input devices 56 may be omitted, as may on/off switches 506, which may be done for the purpose of requiring use of cleaning solution in order for the door to operate, prohibiting a user from circumventing such use. The door operator controller 34, dispenser 50c, 50d, 50e and dispenser controller 602, 702 may be connected to the same or different power sources; one possible embodiment includes a wired power connection to the door operator controller 34 and from the door operator controller 34 to the dispenser 50c, 50d, 50e and as applicable the dispenser controller 602, 702; another embodiment may provide that the dispenser 50c, 50d, 50e and dispenser controller 602, 702 be powered independently, either with a wired connection to the building wiring or with a battery.

The door operator 20 can also be used in a door assembly having a single door, double doors, or multiple doors. For example, two door operators 20 could be provided adjacent to a door frame to open and close opposing doors. The door operator 20 of the present invention may also be provided as part of a retrofitting kit for mounting to a residential or commercial door assembly to thereby convert the door assembly to a selectively automatically operated door. The materials of the door operator 20 may generally be expected to be metal, and in particular steel alloy, but may be as selected by one of ordinary skill in the art.

One application of the embodiments described herein is for use in clean or sterile environments such as hospitals. A hand cleaning station may be electronically connected with an entrance door to a clean environment, and the door may be, for example, an interior door in the building. The user may be required to wash or sanitize his or her hands in order to cause the door to open. When the user activates the dispenser to wash or sanitize his or her hands, the door operator opens the door. Depending on the exit requirements for the safety of those in the room, the door may also initially be locked, and will only unlock upon activation of the dispenser. Such an arrangement may also be provided with an override mode, as may be the case where a key, keypad device, card reader apparatus, or other access control actuation device is furnished. There may be programmed into the system a time delay that will encourage the user to clean his hands for a period of time before the door opens. This arrangement may be selected to preserve the clean environment by only allowing entrance to the clean environment only to those who have performed the sanitary cleaning procedures.

Although the present invention has been shown and described in considerable detail with respect to only a few exemplary embodiments thereof, it should be understood by those skilled in the art that there is no intent to limit the invention to the embodiments since various modifications, omissions, and additions may be made to the disclosed embodiments without materially departing from the novel teachings and advantages of the invention, particularly in light of the foregoing teachings. For example, some of the novel features of the automatic door described herein could be used with any type of powered door operator. Accordingly, it is intended to cover all such modifications, omission, additions, and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A hand cleaner station for opening a door, with a door operator motor and a door operator controller being associated with the door, the hand cleaner station comprising:
a dispenser for dispensing a cleaning material; and
a first input device for causing the dispenser to dispense the cleaning material and to initiate a signal from the dispenser when the first input device is actuated, the signal adapted to cause the door operator controller to direct the door operator motor to open the door.

2. The hand cleaner station of claim 1, further comprising a second input device for causing the dispenser to initiate a signal when the second input device is actuated, and the second input device does not cause the dispenser to dispense the cleaning material, the signal adapted to cause the door operator controller to direct the door operator motor to open the door.

3. The hand cleaner station of claim 1, further comprising a dispenser controller associated with the dispenser.

4. The hand cleaner station of claim 1, wherein the first input device comprises a sensor that is actuated when the sensor detects the presence of hands proximate to the sensor.

5. The hand cleaner station of claim 1, wherein the first input device comprises a mechanical actuator.

6. The hand cleaner station of claim 1, wherein the second input device comprises a sensor that is actuated when the sensor detects the presence of hands proximate to the sensor.

7. The hand cleaner station of claim 1, wherein the second input device comprises a mechanical actuator.

8. The hand cleaner station of claim 1, wherein the dispenser includes means for wireless transmission of the signal.

9. An automatic door operator for a door, comprising:
a motor adapted to be operatively coupled to the door to open the door;
a door operator controller electrically connected to the motor to control the operation of the motor; and
a hand cleaner station in operative communication with the door operator controller, the hand cleaner station comprising:
a dispenser for dispensing a cleaning material; and
a first input device for causing the dispenser to dispense the cleaning material and to initiate a signal from the dispenser when the first input device is actuated, the signal for causing the door operator controller to direct the motor to open the door.

10. The automatic door operator of claim 9, wherein the hand cleaner station further comprises a second input device for causing the dispenser to initiate a signal when the second input device is actuated, and the second input device does not cause the dispenser to dispense cleaning material, the signal for causing the door operator controller to direct the motor to open the door.

11. The automatic door operator of claim 9, further comprising a dispenser controller associated with the dispenser.

12. The automatic door operator of claim 9, wherein the first input device comprises a sensor that is actuated when the sensor detects the presence of hands proximate to the sensor.

13. The automatic door operator of claim 9, wherein the first input device comprises a mechanical actuator.

14. The automatic door operator of claim 9, wherein the second input device comprises a sensor that is actuated when the sensor detects the presence of hands proximate to the sensor.

15. The automatic door operator of claim 9, wherein the second input device comprises a mechanical actuator.

16. The automatic door operator of claim 9, wherein the dispenser includes means for wireless transmission of the signal, and further comprising means for wireless reception of the signal, the means for wireless reception operatively connected to the door operator controller.

17. A method of making a hand cleaner station for opening a door, with a door operator motor and a door operator controller being associated with the door, the method comprising:
providing a dispenser for dispensing a cleaning material;
providing a first input device for causing the dispenser to dispense the cleaning material and to initiate a signal from the dispenser when the first input device is actuated, the signal adapted to cause the door operator controller to direct the door operator motor to open the door; and
providing a second input device for causing the dispenser to initiate a signal when the second input device is actuated, and the second input device does not cause the dispenser to dispense the cleaning material, the signal adapted to cause the door operator controller to direct the door operator motor to open the door.

18. A method of operating an automatic door operator for a door in a doorway, with a door operator motor and a door operator controller being associated with the door, the method comprising:
selecting between use of input devices for operating the door, the input devices comprising:
a first input device for causing the dispenser to dispense a cleaning material and to initiate a signal from the dispenser when the first input device is actuated, the signal adapted to cause the door operator controller to direct the door operator motor to open the door; and
a second input device for causing the dispenser to initiate a signal when the second input device is actuated, and the second input device does not cause the dispenser to dispense the cleaning material, the signal adapted to cause the door operator controller to direct the door operator motor to open the door;
actuating either the first input device or the second input device;
if the first input device is selected, cleaning hands with the cleaning material; and passing through the doorway after the door opens.
